(19) United States
(12) Patent Application Publication
(10) Pub. No.: US 2009/0061948 A1
(43) Pub. Date: Mar. 5, 2009

(54) TERMINAL HAVING ZOOM FEATURE FOR CONTENT DISPLAYED ON THE DISPLAY SCREEN

(75) Inventors: Jin Sang Lee, Gyeonggi-do (KR); Su Jin KIM, Seoul (KR); Jong Ra LIM, Gyeonggi-do (KR); Ki Hyung LEE, Seoul (KR); Chae Guk CHO, Gyenggi-do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG Electronics Inc.

(21) Appl. No.: 12/194,415

(22) Filed: Aug. 19, 2008

(30) Foreign Application Priority Data
Aug. 20, 2007 (KR) 10-2007-0083490

(51) Int. Cl. H04M 1/00; G09G 5/00; G06F 3/041

(52) U.S. Cl. 455/566; 345/660; 345/173

(57) ABSTRACT

A method of graphically resizing content displayed on a portion of a display screen of a mobile communication terminal is provided. The method comprises selecting a first area of an image graphically rendered on a display screen, content in the first area having a first set of dimensions and a first central point in a first relationship with boundaries of the first area; and graphically re-rendering the content in the first area on the display screen such that the content in the first area is displayed on the display screen in a second area of the screen having a second set of dimensions and a second central point having proportionally the first relationship with boundaries of the second area.

### CROSS-REFERENCE TO RELATED APPLICATIONS

This application claims the benefit of the Korean Patent Application No. 10-2007-0083490, filed on Aug. 20, 2007, which is hereby incorporated by reference as if fully set forth herein, pursuant to 35 U.S.C. §. 119(a).

### FIELD OF THE INVENTION

The present disclosure relates generally to a mobile communication terminal, and more particularly, to a mobile communication terminal having feature to allow a user to zoom in or out of an area displayed on the terminal's screen.

### BACKGROUND

A mobile terminal is a device which may be configured to perform various functions. Examples of such functions include data and voice communications, capturing images and video via a camera, recording audio, playing music files via a speaker system, and displaying images and video on a display. Some terminals include additional functionality which supports game playing, while other terminals are configured as multimedia players. Mobile terminals may be configured to receive broadcast and multicast signals which permit viewing of content such as videos and television programs.

Efforts are ongoing to support and increase the functionality of mobile terminals. Such efforts include software and hardware improvements, as well as changes and improvements in the structural components which form the mobile terminal.

For example, in a terminal provided with a navigation system, the terminal is able to provide information on a map, on which a route to a user-specific destination and a terminal position on the route are marked. However, in the case of a user attempting to zoom in or out on a display screen of the mobile terminal that shows a prescribed point on the route, it is inconvenient for a user to manipulate key buttons provided on the terminal several times. Additionally, it is also difficult to zoom in or out on a specific portion of the screen on which a photo, a text message or the like is displayed.

### SUMMARY

A method of graphically resizing content displayed on a portion of a display screen of a mobile communication terminal is provided. The method comprises selecting a first area of an image graphically rendered on a display screen. Content displayed in the first area have a first set of dimensions and a first central point in a first relationship with boundaries of the first area. The content in the first area are rendered on the display screen such that the content in the first area is displayed on the display screen in a second area of the screen having a second set of dimensions and a second central point having proportionally the first relationship with boundaries of the second area.

The second area may be larger than the first area, in response to receiving a first command, and the second area may be smaller than the first area, in response to receiving a second command. The first command may be a command to zoom-in on the first area, and the second command may be a command to zoom-out of the first area.

In one embodiment, selecting the first area comprises drawing a geometric shape around the first area, wherein the first command is associated with a first direction selected to draw the geometric shape, and the second command is associated with a second direction selected to draw the geometric shape. The second direction may be opposite to the first direction. The shape may be approximately an ellipse.

In one embodiment, the first direction is clockwise and the second direction is counter clockwise. Level of zoom-in and zoom-out may be controlled according to speed with which the geometric shape is drawn. Level of zooming and zoom-out may be controlled according to number of times the geometric shape is drawn. The level of zoom-in and zoom-out may be doubled, if speed of the speed with which the geometric shape is drawn is doubled. The level of zoom-in and zoom-out may be doubled if speed of the number of times the geometric shape is drawn is doubled, depending on the implementation.

### BRIEF DESCRIPTION OF THE DRAWINGS

The accompanying drawings, which are included to provide a further understanding of the present disclosure and are incorporated in and constitute a part of this application, illustrate exemplary embodiments.

FIG. 1 is a block diagram of a mobile terminal in accordance with one embodiment.

FIG. 2 is a perspective view of a front side of a mobile terminal according to one embodiment.

FIG. 3 is a rear exemplary view of the mobile terminal shown in FIG. 2.

FIG. 4 is a front exemplary diagram of a terminal according to another embodiment.

FIG. 5 is a front diagram of a terminal according to another embodiment.

FIG. 6 is a flowchart for a method of controlling size of content displayed on a screen, according to one embodiment.

FIG. 7 is a diagram for a first screen configuration for zooming in an image to correspond to an area setting action for a touchscreen according to one embodiment.

FIG. 8 is a diagram for a second screen configuration for zooming in an image to correspond to an area setting action for a touchscreen according to one embodiment.

FIG. 9A and FIG. 9B are diagrams for a third screen configuration for zooming in an image to correspond to an area setting action for a touchscreen according to one embodiment.

FIG. 10 is a diagram for a fourth screen configuration for zooming in an image to correspond to an area setting action for a touchscreen according to one embodiment.

FIG. 11 is a diagram for a first screen configuration for zooming out an image to correspond to an area setting action for a touchscreen according to one embodiment.

FIG. 12 is a diagram for a second screen configuration for zooming out an image to correspond to an area setting action for a touchscreen according to one embodiment.

FIG. 13A and FIG. 13B are diagrams for a third screen configuration for zooming out an image to correspond to an area setting action for a touchscreen according to one embodiment.

FIG. 14 is a diagram for a fourth screen configuration for zooming out an image to correspond to an area setting action for a touchscreen according to one embodiment.

FIG. 15 is a diagram for a first screen configuration for a zoom-in/out process in accordance with a touch pattern on a touchscreen according to one embodiment.

FIG. 16 is a diagram for a second screen configuration for a zoom-in/out process in accordance with a touch pattern on a touchscreen according to one embodiment.

FIG. 17 is a diagram for a third screen configuration for a zoom-in/out process in accordance with a touch pattern on a touchscreen according to one embodiment.

Reference will now be made in detail to the preferred embodiments, examples of which are illustrated in the accompanying drawings. It is to be understood by those of ordinary skill in this technological field that other embodiments may be utilized, and structural, electrical, as well as procedural changes may be made without departing from the scope of the present disclosure. Wherever possible, the same reference numbers will be used throughout the drawings to refer to the same or like parts.

### DETAILED DESCRIPTION OF EXEMPLARY EMBODIMENTS

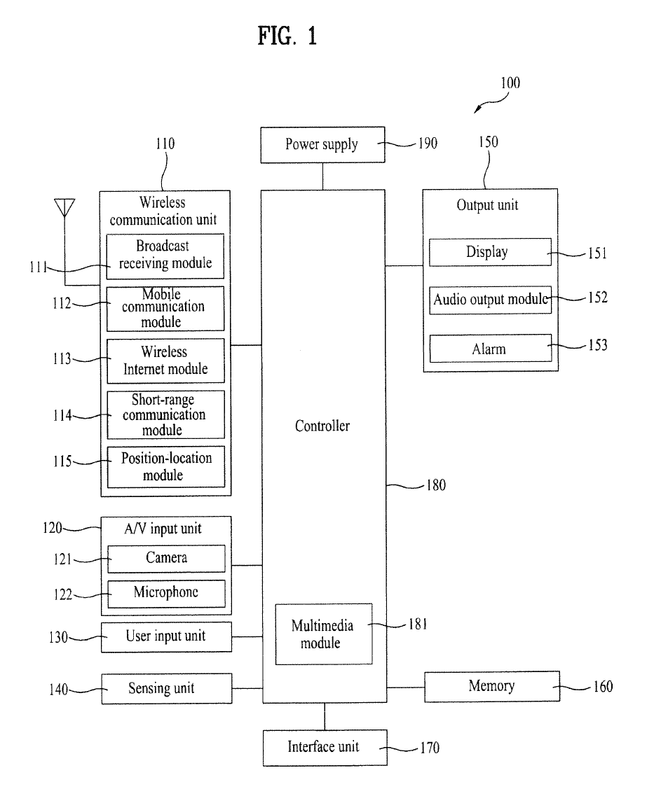

FIG. 1 is a block diagram of mobile terminal 100 in accordance with one embodiment. The mobile terminal may be implemented using a variety of different types of terminals. Examples of such terminals include mobile phones, user equipment, smart phones, computers, digital broadcast terminals, personal digital assistants, portable multimedia players (PMP) and navigators, in addition to many others.

By way of non-limiting example, further description will be given with regard to a mobile terminal 100 as illustrated in the figures. Such teachings apply equally to other types of terminals. FIG. 1 shows the mobile terminal 100 having various components, but it is understood that implementing all of the illustrated components is not a requirement. Greater or fewer components may alternatively be implemented.

FIG. 1 shows a wireless communication unit 110 configured with several commonly implemented components. For instance, the wireless communication unit 110 may include one or more components which permit wireless communication between the mobile terminal 100 and a wireless communication system or network within which a mobile terminal 100 is located.

The broadcast receiving module 111 receives a broadcast signal and/or broadcast associated information from an external broadcast managing entity via a broadcast channel. The broadcast channel may include a satellite channel and a terrestrial channel. The broadcast managing entity refers generally to a system which transmits a broadcast signal and/or broadcast associated information. Examples of broadcast associated information include information associated with a broadcast channel, a broadcast program, a broadcast service provider, etc. For instance, broadcast associated information may include an electronic program guide (EPG) of digital multimedia broadcasting (DMB) and electronic service guide (ESG) of digital video broadcast-handheld (DVB-H).

The broadcast signal may be implemented as a TV broadcast signal, a radio broadcast signal, or a data broadcast signal, among others. If desired, the broadcast signal may further include a broadcast signal combined with a TV or radio broadcast signal. The broadcast receiving module 111 may be configured to receive broadcast signals transmitted from various types of broadcast systems. By way of non-limiting example, such broadcasting systems may include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receipt of multicast signals is also possible. If desired, data received by the broadcast receiving module 111 may be stored in a suitable device, such as memory 160.

The mobile communication module 112 may transmit or receive wireless signals to or from one or more network entities (e.g., base station, Node-B). Such signals may represent audio, video, multimedia, control signaling, or data, among others. The wireless internet module 113 supports Internet access for the mobile terminal 100. This module may be internally or externally coupled to the mobile terminal 100.

The short-range communication module 114 facilitates relatively short-range communications. Suitable technologies for implementing this module include radio frequency identification (RFID), infrared data association (IrDA), ultra-wideband (UWB), as well as the networking technologies commonly referred to as Bluetooth and ZigBee, to name a few. Position-location module 115 identifies or otherwise obtains the location of the mobile terminal 100. If desired, the position-location module 115 may be implemented using global positioning system (GPS) components which cooperate with associated satellites, network components, or combinations thereof.

Audio/video (A/V) input unit 120 is configured to provide audio or video signal input to the mobile terminal 100. As shown, the A/V input unit 120 includes a camera 121 and a microphone 122. The camera may receive and process image frames of still pictures or video. The microphone 122 may receive an external audio signal while the portable device is in a particular mode, such as phone call mode, recording mode or voice recognition mode. The audio signal may be processed and converted into digital data. The portable device, and in particular, A/V input unit 120, may include assorted noise removing algorithms to remove noise generated in the course of receiving the external audio signal. Data generated by the A/V input unit 120 may be stored in memory 160, utilized by output unit 150, or transmitted via one or more modules of communication unit 110. If desired, two or more microphones and/or cameras may be used.

The user input unit 130 generates input data responsive to user manipulation of an associated input device or devices. Examples of such devices include a keypad, a dome switch, a touchpad (e.g., static pressure/capacitance), a jog wheel or a jog switch. A specific example is one in which the user input unit 130 is configured as a touchpad in cooperation with a touchscreen display 151 (which will be described in more detail below).

In one embodiment, the touchscreen display 151 comprises a sensing unit 140 which provides status measurements of various aspects of the mobile terminal 100. For instance, the sensing unit may detect an open or closed status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation of the mobile terminal 100, or acceleration or deceleration of the mobile terminal 100.

As an example, consider the mobile terminal 100 being configured as a slide-type mobile terminal. In this configuration, the sensing unit 140 may sense whether a sliding portion of the mobile terminal 100 is open or closed. Other examples include the sensing unit 140 sensing the presence or absence of power provided by the power supply 190, or the presence or absence of a coupling or other connection between the interface unit 170 and an external device.

The interface unit 170 is often implemented to couple the mobile terminal 100 with external devices. Typical external devices include wired/wireless headphones, external chargers, power supplies, storage devices configured to store data (e.g., audio, video, pictures, etc.), earphones, and microphones, among others. The interface unit 170 may be configured using a wired/wireless data port, a card socket (e.g., for coupling to a memory card, subscriber identity module (SIM) card, user identity module (UIM) card, removable user identity module (RUIM) card), audio input/output ports or video input/output ports.

The output unit 150 generally includes various components which support the output requirements of the mobile terminal 100. Touch screen display 151 is implemented to visually display information associated with the mobile terminal 100. For instance, if the mobile terminal 100 is operating in a phone call mode, the display will generally provide a user interface or graphical user interface which includes information associated with placing, conducting, and terminating a phone call. As another example, if the mobile terminal 100 is in a video call mode or a photographing mode, the display 151 may additionally or alternatively display images which are associated with these modes.

One particular implementation includes the display 151 configured as a touch screen working in cooperation with an input device, such as a touchpad. This configuration permits the display to function both as an output device and an input device. The display 151 may be implemented using known display technologies including, for example, a liquid crystal display (LCD), a thin film transistor-liquid crystal display (TFT-LCD), an organic light-emitting diode display (OLED), a flexible display or a three-dimensional display. The mobile terminal 100 may include one or more of such displays. An example of a two-display embodiment is one in which one display is configured as an internal display (viewable when the terminal is in an opened position) and a second display configured as an external display (viewable in both the open and closed positions).

FIG. 1 further shows output unit 150 having an audio output module 152 which supports the audio output requirements of the mobile terminal 100. The audio output module 152 is often implemented using one or more speakers, buzzers, or other audio producing devices, or combinations thereof. The audio output module 152 functions in various modes including call-receiving mode, call-placing mode, recording mode, voice recognition mode and broadcast reception mode. During operation, the audio output module 152 outputs audio relating to a particular function (e.g., call received, message received, and errors).

The output unit 150 is further shown having an alarm 153, which is commonly used to signal or otherwise identify the occurrence of a particular event associated with the mobile terminal 100. Typical events include call received, message received or user input received. An example of such output includes the providing of tactile sensations (e.g., vibration) to a user. For instance, the alarm 153 may be configured to vibrate responsive to the mobile terminal 100 receiving a call or message. As another example, vibration may be provided by alarm 153 responsive to receiving user input at the mobile terminal 100, thus providing a tactile feedback mechanism. It is understood that the various output provided by the components of output unit 150 may be separately performed, or such output may be performed using any combination of such components.

The memory 160 is generally used to store various types of data to support the processing, control, and storage requirements of the mobile terminal 100. Examples of such data include program instructions for applications operating on the mobile terminal 100, contact data, phonebook data, messages, pictures, video, etc. The memory 160 shown in FIG. 1 may be implemented using any type (or combination) of suitable volatile and non-volatile memory or storage devices including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, card-type memory, or other similar memory or data storage device.

The controller 180 typically controls the overall operations of the mobile terminal 100. For instance, the controller 180 performs the control and processing associated with voice calls, data communications, video calls, camera operations and recording operations. If desired, the controller 180 may include a multimedia module 181 which provides multimedia playback. The multimedia module 181 may be configured as part of the controller 180, or this module may be implemented as a separate component.

The power supply 190 provides power required by the various components for the portable device. The provided power may be internal power, external power, or combinations thereof. Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory (for example, memory 160), and executed by a controller or processor (for example, controller 180).

Mobile terminal 100 may be implemented in a variety of different configurations. Examples of such configurations include folder-type, slide-type, bar-type, rotational-type, swing-type and combinations thereof. For clarity, further disclosure will primarily relate to a slide-type mobile terminal. However, such teachings apply equally to other types of terminals.

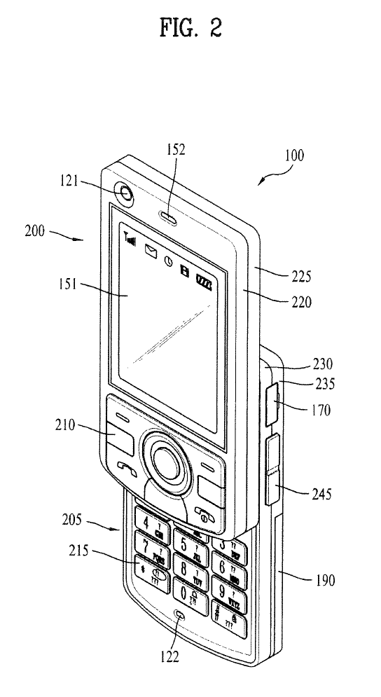

FIG. 2 is a perspective view of a front side of a mobile terminal 100 according to one embodiment. In FIG. 2, the mobile terminal 100 is shown having a first body 200 configured to slideably cooperate with a second body 205. The user input unit (described in FIG. 1) is implemented using function keys 210 and keypad 215. The function keys 210 are associated with the first body 200, and the keypad 215 is associated with the second body 205. The keypad includes various keys (e.g., numbers, characters, and symbols) to enable a user to place a call, prepare a text or multimedia message, and otherwise operate the mobile terminal 100.

The first body 200 slides relative to second body 205 between open and closed positions. In a closed position, the first body 200 is positioned over the second body 205 in such a manner that the keypad 215 is substantially or completely obscured by the first body 200. In the open position, the user has access to the keypad 215, as well as the display 151 and function keys 210. The function keys 210 are convenient to a user for entering commands such as start, stop and scroll.

The mobile terminal 100 is operable in either a standby mode (e.g., able to receive a call or message, receive and respond to network control signaling), or an active call mode. Typically, the mobile terminal 100 functions in a standby mode when in the closed position, and an active mode when in the open position. This mode configuration may be changed as required or desired.

The first body 200 is shown formed from a first case 220 and a second case 225, and the second body 205 is shown formed from a first case 230 and a second case 235. The first and second cases are usually formed from a suitably ridge material such as injection molded plastic, or formed using metallic material such as stainless steel (STS) and titanium (Ti).

If desired, one or more intermediate cases may be provided between the first and second cases of one or both of the first and second bodies 200, 205. The first and second bodies 200, 205 are typically sized to receive electronic components necessary to support operation of the mobile terminal 100. The first body 200 is shown having a camera 121 and audio output unit 152, which is configured as a speaker, positioned relative to the display 151. If desired, the camera 121 may be constructed in such a manner that it can be selectively positioned (e.g., rotated, swiveled, etc.) relative to first body 200.

The function keys 210 are positioned adjacent to a lower side of the display 151. The display 151 is shown implemented as an LCD or OLED. Recall that the display may also be configured as a touchscreen having an underlying touchpad which generates signals responsive to user contact (e.g., finger, stylus, etc.) with the touchscreen.

Second body 205 is shown having a microphone 122 positioned adjacent to keypad 215, and side keys 245, which are one type of a user input unit, positioned along the side of second body 205. Preferably, the side keys 245 may be configured as hot keys, such that the side keys are associated with a particular function of the mobile terminal 100. An interface unit 170 is shown positioned adjacent to the side keys 245, and a power supply 190 in a form of a battery is located on a lower portion of the second body 205.

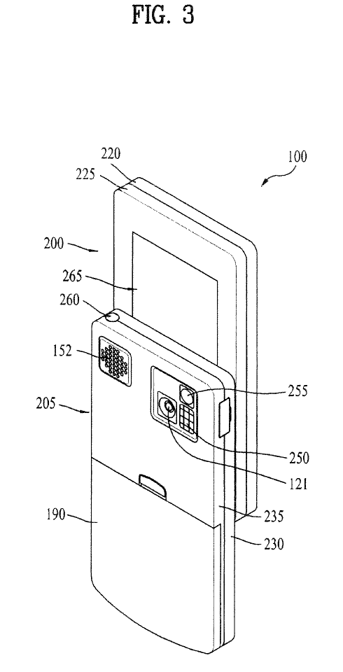

FIG. 3 is a rear view of the mobile terminal 100 shown in FIG. 2. FIG. 3 shows the second body 205 having a camera 121, and an associated flash 250 and mirror 255. The flash 250 operates in conjunction with the camera 121 of the second body 205. The mirror 255 is useful for assisting a user to position camera 121 in a self-portrait mode. The camera 121 of the second body 205 faces a direction which is opposite to a direction faced by camera 121 of the first body 200 (FIG. 2). Each of the cameras 121 of the first 200 and second 205 bodies may have the same or different capabilities.

In an embodiment, the camera 121 of the first body 200 operates with a relatively lower resolution than the camera 121 of the second body 205. Such an arrangement works well during a video conference, for example, in which reverse link bandwidth capabilities may be limited. The relatively higher resolution of the camera 121 of the second body 205 (FIG. 3) is useful for obtaining higher quality pictures for later use or for communicating to others.

The second body 205 also includes an audio output module 152 configured as a speaker, and which is located on an upper side of the second body 205. If desired, the audio output modules of the first and second bodies 200, 205, may cooperate to provide stereo output. Moreover, either or both of these audio output modules may be configured to operate as a speakerphone.

A broadcast signal receiving antenna 260 is shown located at an upper end of the second body 205. Antenna 260 functions in cooperation with the broadcast receiving module 111 (see FIG. 1). If desired, the antenna 260 may be fixed or configured to retract into the second body 205. The rear side of the first body 200 includes slide module 265, which slideably couples with a corresponding slide module located on the front side of the second body 205.

It is understood that the illustrated arrangement of the various components of the first and second bodies 200, 205, may be modified as required or desired. In general, some or all of the components of one body may alternatively be implemented on the other body. In addition, the location and relative positioning of such components are not critical to many embodiments, and as such, the components may be positioned at locations which differ from those shown by the representative figures.

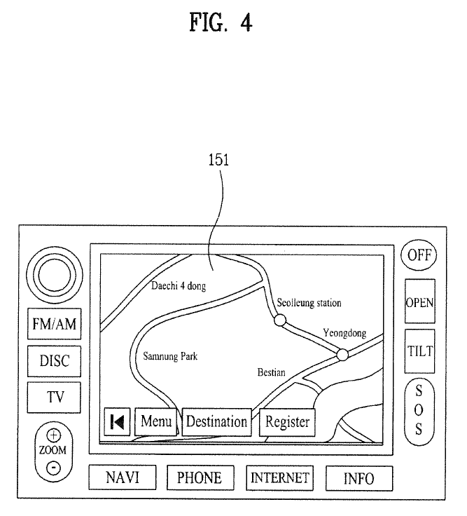

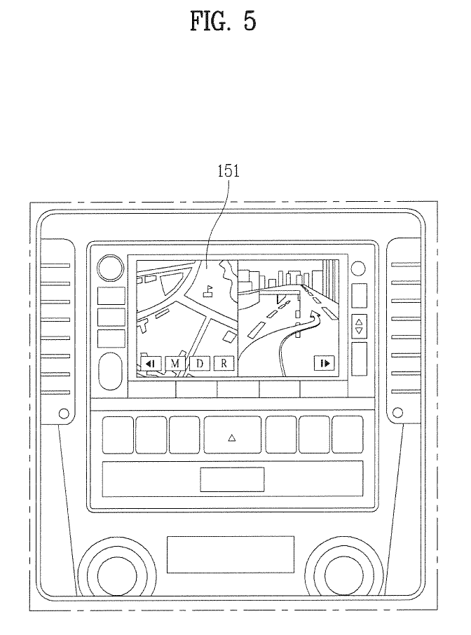

Referring to FIG. 4 or FIG. 5, vehicle navigation system shown in can be detachably provided to a vehicle. Moreover, the mobile phone type terminal 100 shown in FIG. 2 or FIG. 3 can be detachably provided to a vehicle to fully play a role as a vehicle navigation system. Operational relations between the respective elements for implementing a screen size controlling function are explained with reference to FIG. 1 below.

In one embodiment, a the controller 180 determines an area of the display 151 that corresponds to a user's touching the screen. The controller 180 causes a zoom function to be applied to a portion of an image displayed on a touchscreen by way of zooming in or zooming out. For example, the image displayed on the touchscreen may contain a map image, on which a route based on position information and a position on the route are displayed, an image for displaying such information as a photo or a text, and the like. Accordingly, the touchscreen may display an entire image as a result of a zoom-out operation and a portion of the image as a result of a zoom-in operation.

In one embodiment, the alarm output module 153 is able to output vibration as a feedback of the zoom-in or zoom-out action. The mobile terminal 100 is able to generate information necessary for performing a specific function by itself or can be provided with the corresponding information by an external server (not shown in the drawing). The mobile terminal 100 of FIGS. 1 to 5 may be configured to operate within a communication system which transmits data via frames or packets, including both wireless, wired or satellite-based communication systems. Such communication systems utilize different air interfaces and/or physical layers.

Examples of such air interfaces utilized by the communication systems include frequency division multiple access (FDMA), time division multiple access (TDMA), code division multiple access (CDMA), universal mobile telecommunications system (UMTS), the long term evolution (LTE) of the UMTS, and the global system for mobile communications (GSM). By way of non-limiting example only, further description will relate to a CDMA communication system, but such teachings apply equally to other system types.

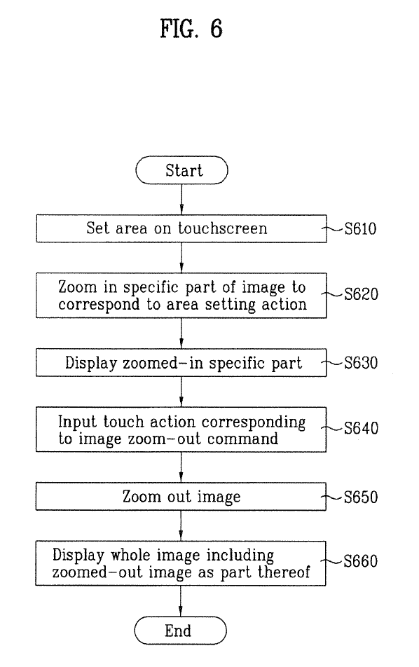

Referring to FIG. 6, the terminal 100 sets an area on the touchscreen to correspond to a user's touch action to the touchscreen [S610]. In this case, the area may mean an inner area of a looped curve drawn on the touchscreen. Even if a curve is drawn on the touchscreen instead of the looped curve, the terminal 100 analogizes a looped curve most similar to the drawn curve and is then able to recognize an inner area of the analogized looped curve as the set area. The memory 160 can store information on a looped curve most similar to a curve.

When a point on the touchscreen is touched, the mobile terminal 100 recognizes an inner area of a circle, which has a predetermined radius centering on the touched point, as the set area. In this case, the radius of the circle can be set proportional to a touch time of the prescribed point, a touch pressure of the prescribed point or the like, for example.

The mobile terminal 100 zooms in a portion of the image displayed on the touchscreen to correspond to the area setting action [S620]. The mobile terminal 100 displays the portion of the image displayed on the touchscreen, which was zoomed in by the zoom-in step S620, on the touchscreen [S630]. In the zoom-in step S620, the mobile terminal 100 is able to perform a zoom-in action with reference to a specific point corresponding to the set area in the image displayed on the touchscreen. In this case, the part corresponding to the set area may be an image or part of an image displayed within the set area.

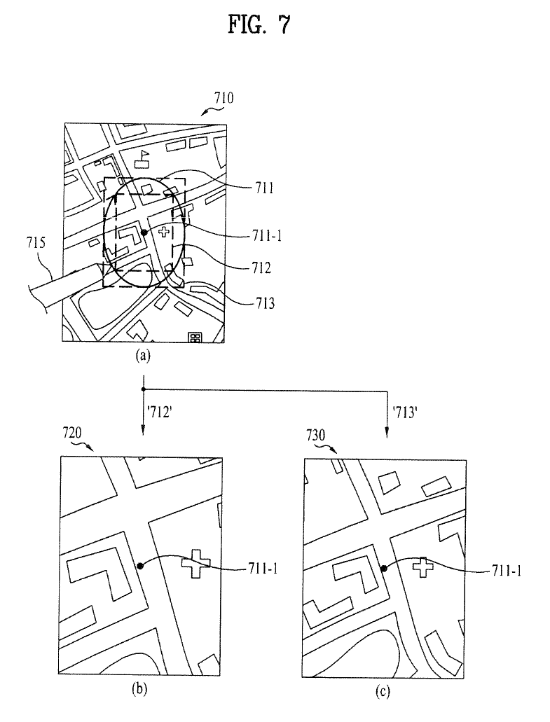

For instance, the mobile terminal 100 is able to perform the zoom-in action with reference to a random point of the image corresponding to the set area, and more particularly, to a center point. In particular, in the drawings shown in FIGS. 7 to 10, a reference point of the image zoom-in is the center point of the set area. It should be understood that a reference point of an image zoom-in or zoom-out can be any point within the set area (not shown in the drawings).

The mobile terminal 100 is able to zoom in a part corresponding to the set area in the image displayed on the touchscreen into a whole image. For this, a process for zooming in an image to correspond to an area setting action for the touchscreen is explained with reference to FIG. 7 in aspect of an image configuration as follows. In FIG. 7, assume that a map, on which a moving route of the mobile terminal 100 is marked, is displayed as a result of driving the position-location module 115.

Referring to FIG. 7, a user draws a circle 711 formed clockwise on the touchscreen using a pointer 715. In this case, the mobile terminal 100 may set an area of the image to an inner area of the circle drawn by the user. The mobile terminal 100 may then be able to recognize a first rectangle 712, which is inscribed in the circle 711 to have a diameter of the circle 711 as a diagonal length, and a second rectangle 713 which is circumscribed to the circle 711 to have a diameter of the circle 711 as a side length. Referring to FIG. 7(a), any figure forming a looped curve is possible for the area setting as well as the circle 711.

In one embodiment, the mobile terminal 100 is able to zoom in a part of the image displayed which corresponds to the first rectangle 712, into a whole image [See FIG. 7(b)]. In this case, the mobile terminal 100 may then perform a zoom-in action with reference to a center 711-1 of the circle 711. The mobile terminal 100 is able to zoom in a part of the image displayed in FIG. 7(a), which corresponds to the second rectangle 713, into a whole image as show in FIG. 7(c). In this case, the mobile terminal 100 may perform a zoom-in action with reference to a center 711-1 of the circle 711 as well.

Occasionally, the part corresponding to the first rectangle 712 or the second rectangle 713 can be zoomed in into a partial image instead of the whole image. In this case, a presence or non-presence of setting the partial image and a size of the partial image can be set by a user or the mobile terminal 100. The mobile terminal 100 is able to zoom in a specific part of an image displayed on the touchscreen to a zoom-in extent in proportion to a continuous repetition count of the area setting action. In this case, the zoom-in extent can include a zoom-in scale using a reduced scale of a map. For instance, if the reduced scale is changed into 1:25,000 from 1:50,000, the zoom-in scale is doubled.

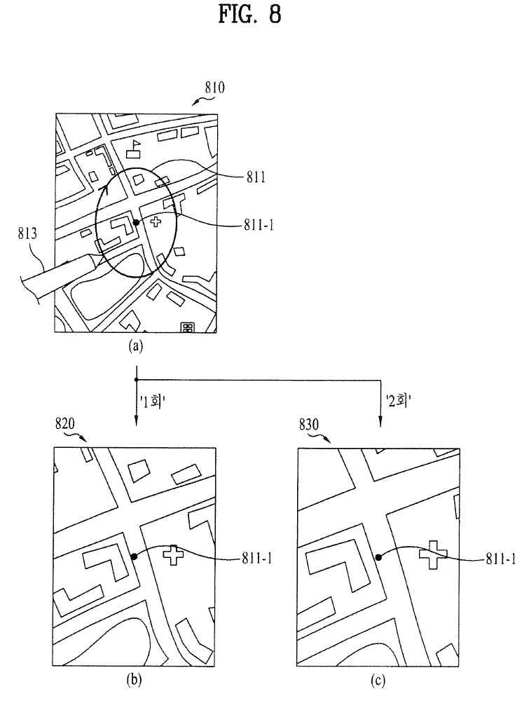

In one embodiment, a process for zooming in an image to correspond to an area setting action for the touchscreen is explained with reference to FIG. 8 in aspect of an image configuration as follows. In FIG. 8, assume that a map, on which a moving route of the terminal 100 is marked, is displayed as a result of driving the position-location module 115.

Referring to FIG. 8, a user draws a circle 811 formed clockwise on the touchscreen using a pointer 813. In this case, the mobile terminal 100 recognizes a center 811-1 of the circle 811 and a count of actions for setting the circle 811. In case that the circle 811 is drawn ‘once’ in the state (a), the mobile terminal 100 may zoom in a specific part of the image displayed in the state (a) centering on the center 811-1 of the circle 811 to a zoom-in extent corresponding to ‘one time’ of the area setting action (See FIG. 8(b)).

In case that the circle 811 is drawn ‘twice’ along a same trace in FIG. 8(a), the mobile terminal 100 may zooms in a specific part of the image centering on the center 811-1 of the circle 811 to a zoom-in extent corresponding to ‘two times’ of the area setting action (See FIG. 8(c)). Accordingly, the mobile terminal 100 is able to display an image zoomed in to the zoom-in extent corresponding to the area setting action ‘two times’ faster than if it would do it one zoom-in step at a time. Step by step, if the area setting action is completed, the mobile terminal 100 may first display an image zoomed in by a zoom-in extent corresponding to the area setting action ‘one time’. Subsequently, if the area setting action is completed ‘two times’, the mobile terminal 100 is able to display an image zoomed in to a zoom-in extent corresponding to the area setting action zoomed-in ‘two times’.

In this case, the zoom-in extent per the area setting action count can be previously stored in the memory 160. And, the zoom-in extent per the area setting action count can be set by a user or the mobile terminal 100. The zoom-in extent per the area setting action count can be set proportional to a continuous repetition count of the area setting actions. For instance, a zoom-in extent corresponding to an area setting action ‘one time’ can be two times. A zoom-in extent corresponding to area setting actions ‘two times’ can be four times. Thus, as the continuous repetition count of the area setting actions gets incremented, it is able to set a greater zoom-in extent. On the contrary, it is understood that the zoom-in extent per the area setting action count can be set inversely proportional to a continuous repetition count of the area setting actions.

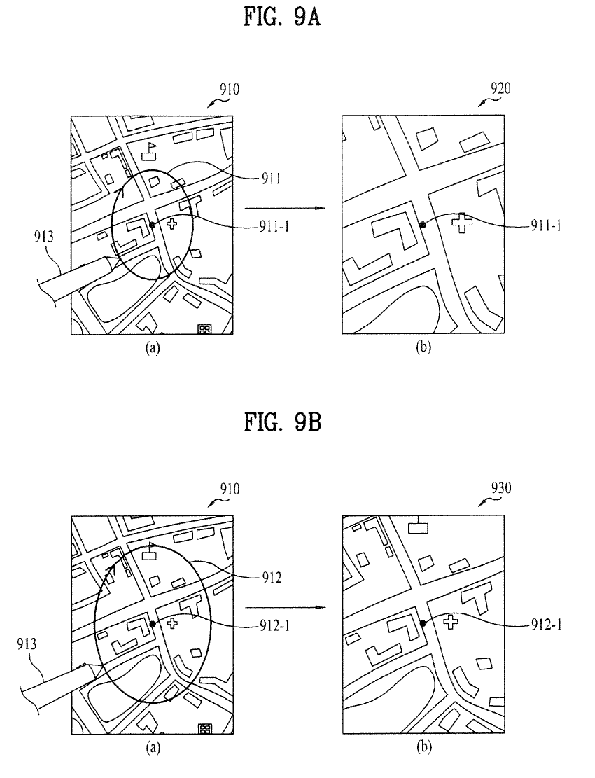

In one embodiment, the terminal is able to zoom in a specific part of an image displayed on the touchscreen to a zoom-in extent inverse proportional to a size of the set area. A process for zooming in an image to correspond to an area setting action for the touchscreen is explained with reference to FIG. 9A and FIG. 9B. In FIG. 9A and FIG. 9B, assume that a map, on which a moving route of the mobile terminal 100 is marked, is displayed as a result of driving the position-location module 115.

Referring to FIG. 9A, a user draws a circle 911 formed clockwise on the touchscreen using a pointer 913. In this case, the mobile terminal 100 may then recognize a center 911-1 of the circle 911 and a size of the circle 911. Subsequently, the mobile terminal 100 displays a specific part of an image displayed in FIG. 9A(a) centering on the center 911-1 to a zoom-in extent corresponding to the size (generally, it can be determined as a diameter or radius of the circle) of the circle 911 in a manner of zooming in the corresponding (See FIG. 9A(b)).

Referring to FIG. 9B(a), a user draws a circle 912 formed clockwise on the touchscreen using a pointer 913. In this case, the mobile terminal 100 recognizes a center 912-1 of the circle 912 and a size of the circle 912. And, assume that the size of the circle 912 shown in FIG. 9B is twice larger than that of the former circle 911 shown in FIG. 9A. Subsequently, the terminal mobile 100 displays a specific part of an image displayed centering on the center 912-1 to a zoom-in extent corresponding to the size of the circle 912 in a manner of zooming in the corresponding part.

In this case, a zoom-in extent per area size can be stored in the memory 160. And, a zoom-in extent per area size can be set by a user or the mobile terminal 100. Moreover, a zoom-in extent per area size can be set inversely proportional to an area size. For instance, a zoom-in extent corresponding to a radius ‘1 cm’/‘2 cm’ of a circle forming an area may correspond to ‘four time’/‘two times’. Hence, it is able to set the zoom-in extent smaller as the area size gets larger. It should be understood that the zoom-in extent per the area size can also be set proportional to the area size.

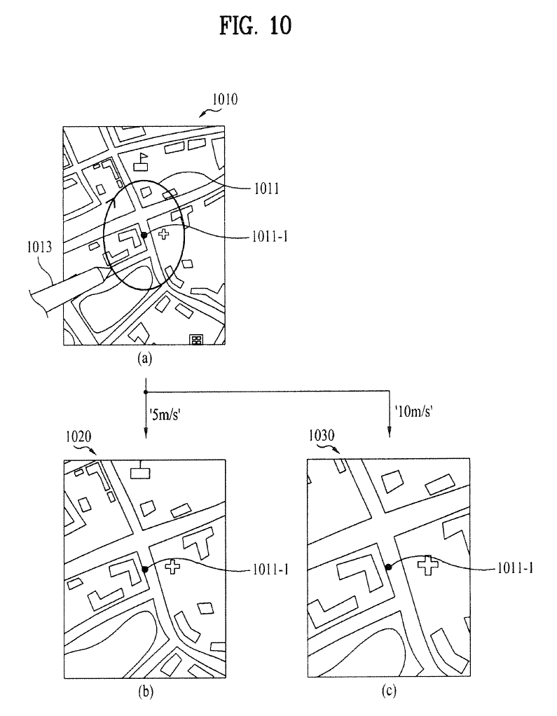

The mobile terminal 100 is able to display a specific part of an image displayed on the touchscreen in a manner of zooming in the specific part to a zoom-in extent proportional to a speed of a drag action for setting an area. For this, a process for zooming in an image to correspond to an area setting action for the touchscreen is explained with reference to FIG. 10 in aspect of an image configuration as follows. In FIG. 10, assume that a map, on which a moving route of the terminal 100 is marked, is displayed as a result of driving the position-location module 115.

Referring to FIG. 10(a), a user draws a circle 1011 formed clockwise on the touchscreen using a pointer 1013. In this case, the mobile terminal 100 recognizes a speed of a drag action for setting a center 1011-1 of the circle 1011 and a size of the circle 1011. If a drag speed is ‘5 m/s’, for example, the terminal displays a specific part of an image displayed centering on the center 1011-1 in a manner of zooming in the specific part to a zoom-in extent corresponding to the drag speed ‘5 m/s’, for example, as shown in FIG. 10(b).

If a drag speed FIG. 10(a) is ‘10 m/s’, for example, the mobile terminal 100 displays a specific part of an image displayed centering on the center 1011-1 in a manner of zooming in the specific part to a zoom-in extent corresponding to the drag speed of ‘10 m/s’ FIG. 10(c). In this case, a zoom-in extent per drag speed can be stored in the memory 160. And, a zoom-in extent per drag speed can be set by a user or the mobile terminal 100.

Moreover, a zoom-in extent per drag speed can be set proportional to a drag speed. For instance, a zoom-in extent corresponding to a drag speed ‘5 m/s’/‘10 m/s’ may correspond to ‘four time’/‘two times’. Hence, it is able to set the zoom-in extent greater as the drag speed gets higher. It is understood that the zoom-in extent per the drag speed can be set inverse proportional to the drag speed.

Referring now to FIG. 6, a user inputs a touch action corresponding to an image zoom-out command to the mobile terminal 100 via the touchscreen [S640]. In this case, the touch action corresponding to the image zoom-out command can include an area setting action performed by the user on the touchscreen. For instance, in case that a looped curve having an inner area is drawn on the touchscreen by the area setting action, the mobile terminal 100 can recognize that the touch action corresponding to the image zoom-out command has been input thereto. In this case, if a curve is drawn instead of the looped curve, the mobile terminal 100 is able to analogize a looped curve most similar to the drawn curve.

A touch action according to a touch count corresponding to the image zoom-out command, a touch pressure, a touch direction or a touch time may also be input as the touch action corresponding to the image zoom-out command to the mobile terminal 100. In the following description, the touch action corresponding to the image zoom-out command is explained by limiting it to a user's area setting action for the touchscreen. In one embodiment, the mobile terminal 100 obtains a pattern of an area setting action and is then able to discriminate whether the area setting action is provided for an image zoom-in or an image zoom-out.

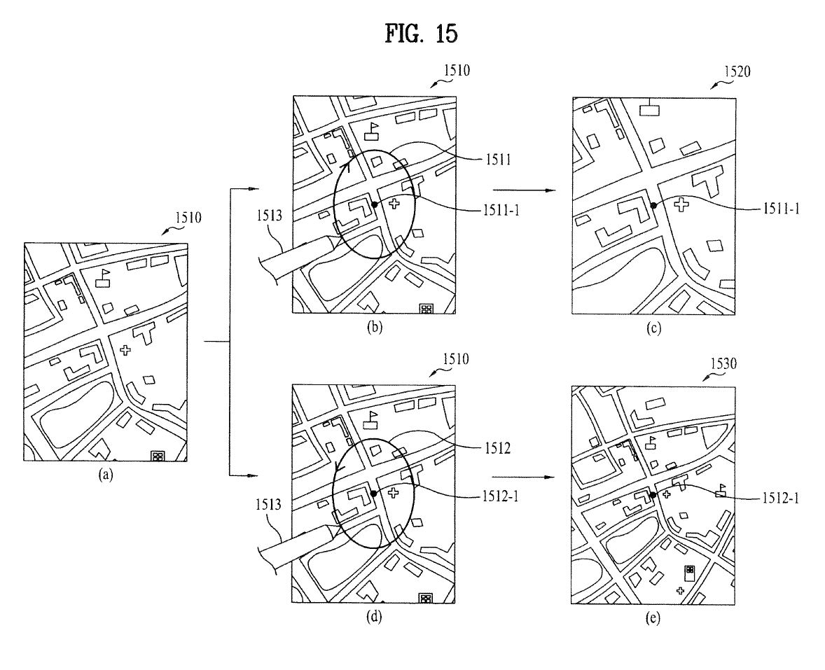

For instance, the mobile terminal 100 may be able to discriminate whether the area setting action is for the image zoom-in or the image zoom-out according to a drag direction of an area, a position of a point touched by a pointer after area setting, or a last position of the pointer according to an area setting completion. This will be explained in the following description with reference to FIGS. 15 to 17.

In one embodiment, the mobile terminal 100 may directly enter the step S640 without passing through the above-described steps S610 to S630 (image zooming-in and displaying steps) or may not perform steps after the step S640 (image zooming-out and displaying steps) after completion of the steps S610 to S630. This is because the process according to the image zoom-in and the process according to the image zoom-out in the present invention may be separately executed.

The mobile terminal 100 zooms out the image displayed on the touchscreen to correspond to the touch action corresponding to the image zoom-out command input in the inputting step S640, e.g., to the area setting action [S650]. The mobile terminal 100 then displays a whole image including the image zoomed out in the zooming-out step S650 on the touchscreen [S660]. In the zooming-out step S650, the mobile terminal 100 is able to perform a zoom-out action with reference to a specific point of the part corresponding to the set area on the image displayed on the touchscreen. In this case, the area and the part corresponding to the set area are similar to those mentioned in the foregoing description, of which details are omitted in the following description.

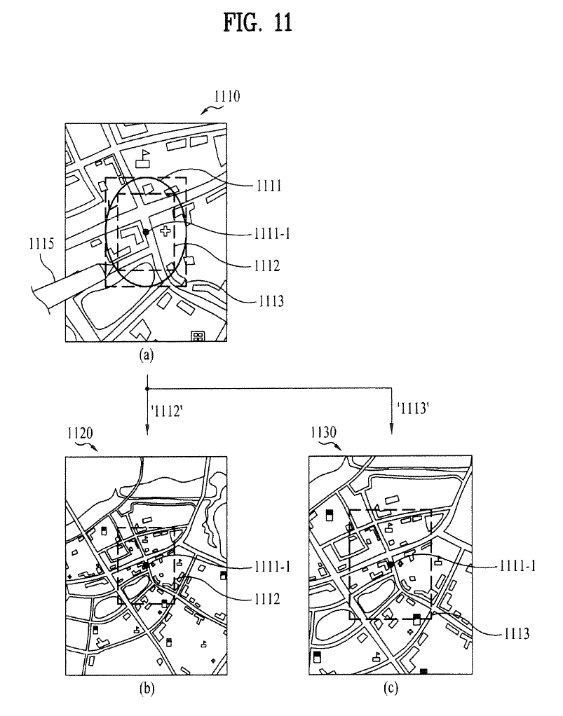

In one embodiment, the mobile terminal 100 is able to perform the zoom-out action with reference to a random point within the image part corresponding to the set area, and preferably, with reference to a center thereof. In detail, FIGS. 11 to 14 show that the reference point of the image zoom-out is the center of the set area. The mobile terminal 100 is able to zoom out the mage displayed on the touchscreen into the part corresponding to the set area.

A process for zooming out an image to correspond to an area setting action for the touchscreen is explained with reference to FIG. 11 in aspect of an image configuration as follows. In FIG. 11, assume that a map, on which a moving route of the mobile terminal 100 is marked, is displayed as a result of driving the position-location module 115.

Referring to FIG. 11, a user draws a circle 1111 formed counterclockwise on the touchscreen using a pointer 1115[a]. In this case, the mobile terminal 100 may set an area of the present invention to an inner area of the circle drawn by the user. The mobile terminal 100 is then able to recognize a first rectangle 1112, which is inscribed in the circle 1111 to have a diameter of the circle 1111 as a diagonal length, and a second rectangle 1113 which is circumscribed to the circle 1111 to have a diameter of the circle 1111 as a side length.

The mobile terminal 100 is able to zoom out a whole image displayed in the state (a) to be displayed within the first rectangle 1112. In this case, the mobile terminal 100 performs a zoom-out action with reference to a center 1111-1 of the circle 1111. Therefore, the mobile terminal 100 zooms out the whole image displayed in the state (a) to become a specific part of another whole picture.

The mobile terminal 100 is able to zoom out a whole image displayed to be displayed within the second rectangle 1113. In this case, the mobile terminal 100 performs a zoom-out action with reference to a center 1111-1 of the circle 1111. And, the mobile terminal 100 may zoom out the whole image displayed in the state (a) to become a specific part of another whole picture.

Occasionally, the zoom-out action and the displaying action according to the zoom-out action can be performed on a partial area of the touchscreen. In this case, a presence or non-presence of setting the partial area and a size of the partial area can be set by a user or the mobile terminal 100. The mobile terminal 100 is able to zoom out a specific part of an image displayed on the touchscreen to a zoom-out extent in proportion to a continuous repetition count of the area setting action.

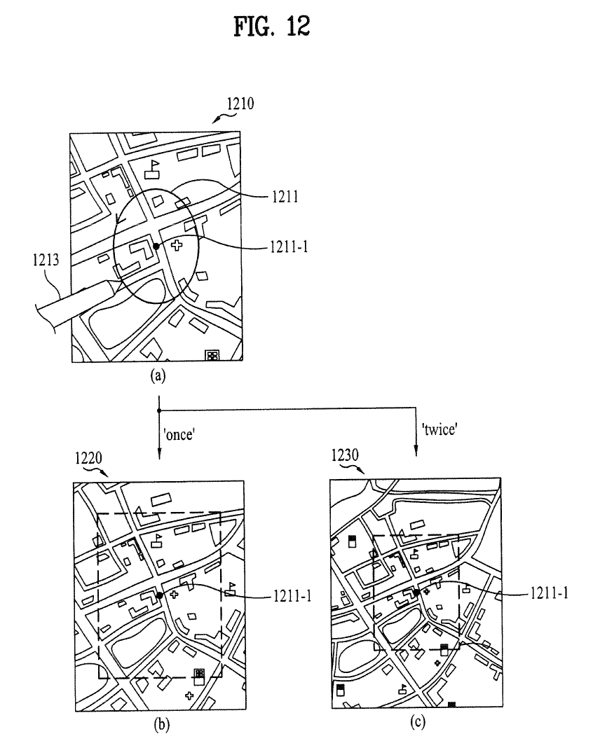

For this, a process for zooming out an image to correspond to an area setting action for the touchscreen is explained with reference to FIG. 12 in aspect of an image configuration as follows. In FIG. 12, assume that a map, on which a moving route of the mobile terminal 100 is marked, is displayed as a result of driving the position-location module 115. Referring to FIG. 12, a user draws a circle 1211 formed counterclockwise on the touchscreen using a pointer 1213. In this case, the mobile terminal 100 recognizes a center 1211-1 of the circle 1211 and a count of setting actions for the circle 1211.

In case that the circle 1211 is drawn ‘one time’, the mobile terminal 100 zooms out an image displayed centering on the center 1211-1 to a zoom-out extent corresponding to an area setting action ‘one time’ and then displays a whole image including the zoomed-out image as a part thereof. In this case, the zoom-out extent can include a zoom-out scale using a reduced scale of map. For instance, in case that a reduced scale is changed into 1:100,000 from 1:50,000, the zoom-out scale becomes a half.

In case that the circle 1211 is continuously drawn ‘twice’ along a same trace, the mobile terminal 100 zooms out the image displayed centering on the center 1211-1 of the circle 1211 to a zoom-out extent corresponding to ‘two times’ of the area setting action and displays a whole image including the zoomed-out image. In this case, the zoom-out extent per the area setting action count can be previously stored in the memory 160. And, the zoom-out extent per the area setting action count can be set by a user or the mobile terminal 100.

The zoom-out extent per the area setting action count can be set proportional to a continuous repetition count of the area setting actions. For instance, a zoom-out extent corresponding to an area setting action ‘one time’ can be ½ time. And, a zoom-out extent corresponding to area setting actions ‘two times’ can be ¼ time. Thus, as the continuous repetition count of the area setting actions gets incremented, it is able to set a greater zoom-out extent. On the contrary, it is understood that the zoom-out extent per the area setting action count can be set inverse proportional to a continuous repetition count of the area setting actions.

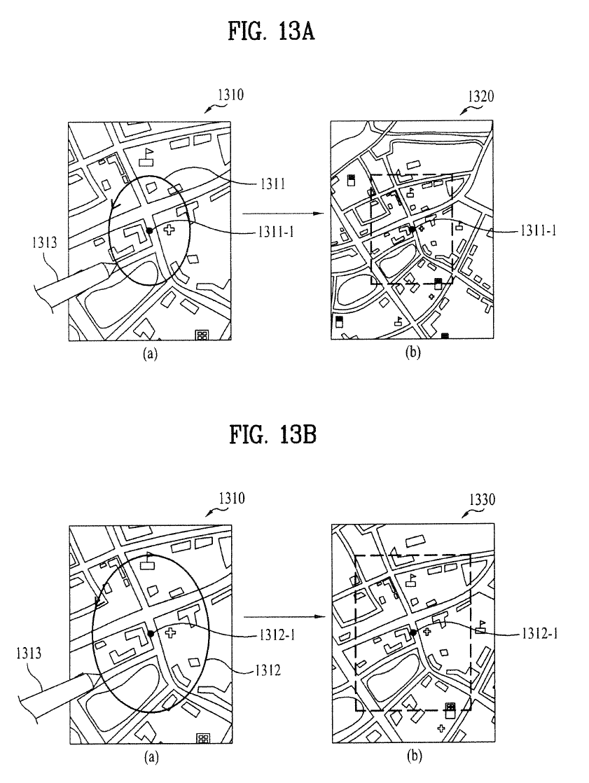

The mobile terminal 100 is able to zoom out a specific part of an image displayed on the touchscreen to a zoom-out extent inversely proportional to a size of the set area. For this, a process for zooming out an image to correspond to an area setting action for the touchscreen is explained with reference to FIG. 13A and FIG. 13B in aspect of an image configuration as follows. In FIG. 13A and FIG. 13B, assume that a map, on which a moving route of the mobile terminal 100 is marked, is displayed as a result of driving the position-location module 115.

Referring to FIG. 13A, a user draws a circle 1311 formed counterclockwise on the touchscreen using a pointer 1313. In this case, the mobile terminal 100 recognizes a center 1311-1 of the circle 1311 and a size of the circle 1311. Subsequently, the mobile terminal 100 zooms out an image displayed centering on the center 1311-1 to a zoom-out extent corresponding to the size of the circle 1311 and then displays a whole image including the zoomed-out image as a part thereof.

Referring to FIG. 13B, a user draws a circle 1312 formed counterclockwise on the touchscreen using a pointer 1313. In this case, the mobile terminal 100 recognizes a center 1312-1 of the circle 1312 and a size of the circle 1312. And, assume that the size of the circle 1312 shown in FIG. 13B is twice larger than that of the former circle 1311 shown in FIG. 13A. Subsequently, the mobile terminal 100 zooms out an image displayed in the state (a) centering on the center 1312-1 to a zoom-out extent corresponding to the size of the circle 1312 and then displays a whole image including the zoomed-out image as a part thereof. In this case, a zoom-out extent per area size can be stored in the memory 160. And, a zoom-out extent per area size can be set by a user or the mobile terminal 100.

Moreover, a zoom-out extent per area size can be set inversely proportional to an area size. For instance, a zoom-out extent corresponding to a radius ‘1 cm’/‘2 cm’ of a circle forming an area may correspond to ‘¼ time’/‘½ time’. Hence, it is able to set the zoom-out extent smaller as the area size gets larger. On the contrary, it is understood that the zoom-out extent per the area size can be set proportional to the area size. The mobile terminal 100 is able to zoom out an image displayed on the screen to a zoom-out extent proportional to a speed of a drag action for setting an area.

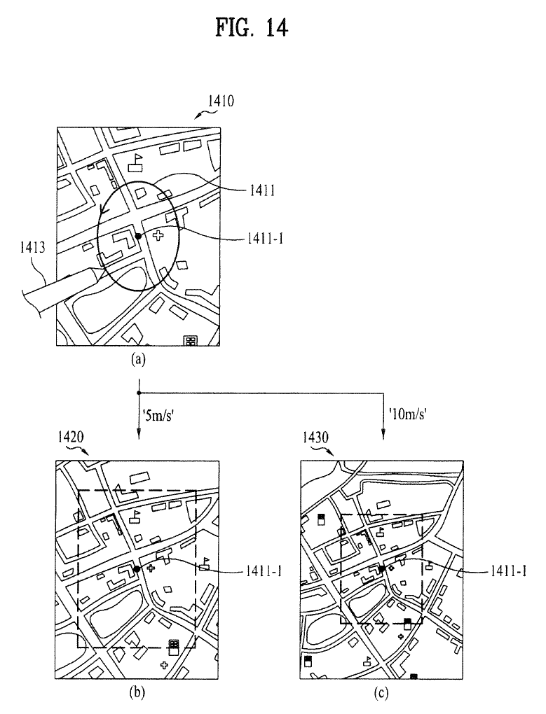

For this, a process for zooming out an image to correspond to an area setting action for the touchscreen is explained with reference to FIG. 14 in aspect of an image configuration as follows. In FIG. 14, assume that a map, on which a moving route of the mobile terminal 100 is marked, is displayed as a result of driving the position-location module 115.

Referring to FIG. 14, a user draws a circle 1411 formed counterclockwise on the touchscreen using a pointer 1413. In this case, the mobile terminal 100 recognizes a speed of a drag action for setting a center 1411-1 of the circle 1411 and a size of the circle 1411. If a drag speed is ‘5 m/s’, for example, the terminal 100 zooms out an image displayed FIG. 14(a) centering on the center 1411-1 to a zoom-out extent corresponding to the drag speed ‘5 m/s’ and then displays a whole image including the zoomed-out image as a part thereof.

If a drag speed is ‘10 m/s’, for example, the terminal 100 zooms out an image centering on the center 1411-1 to a zoom-out extent corresponding to the drag speed ‘10 m/s’ and then displays a whole image including the zoomed-out image as a part thereof. In this case, a zoom-out extent per drag speed can be stored in the memory 160. And, a zoom-out extent per drag speed can be set by a user or the terminal 100.

Moreover, a zoom-out extent per drag speed can be set proportional to a drag speed. For instance, a zoom-out extent corresponding to a drag speed ‘5 m/s’/‘10 m/s’ may correspond to ‘½ time’/‘¼ time’, for example. Hence, it is able to set the zoom-out extent greater as the drag speed gets higher. On the contrary, it is understood that the zoom-out extent per the drag speed can be set inverse proportional to the drag speed.

Meanwhile, the mobile terminal 100 is able to perform the steps S610 to S630 (image zooming-in and displaying steps) after execution of the steps S640 to S660 (image zooming-out and displaying steps). This is because the present disclosure can perform the image zooming-out action and the image zooming-in action by changing their orders.

In the following description, an image zoom-in/zoom-out process according to a touch pattern for a touchscreen according to one embodiment is explained with reference to FIGS. 15 to 17. In the following description, assume that an area for image zoom-in/out is an inner area of a circle drawn by a user. In FIGS. 15 to 17, assume that a map, on which a moving route of the mobile terminal 100 is marked, is displayed as a result of driving the position-location module 115.

FIG. 15 is a diagram for a first screen configuration for a zoom-in/out process in accordance with a touch pattern on a touchscreen according to one embodiment. Referring to FIG. 15, in case that a circle 1511 for an area setting is drawn ‘clockwise’ on the touchscreen, the mobile terminal 100 recognizes a touch action as an image zoom-in command and then displays an image 1510 by zooming in the image 1510.

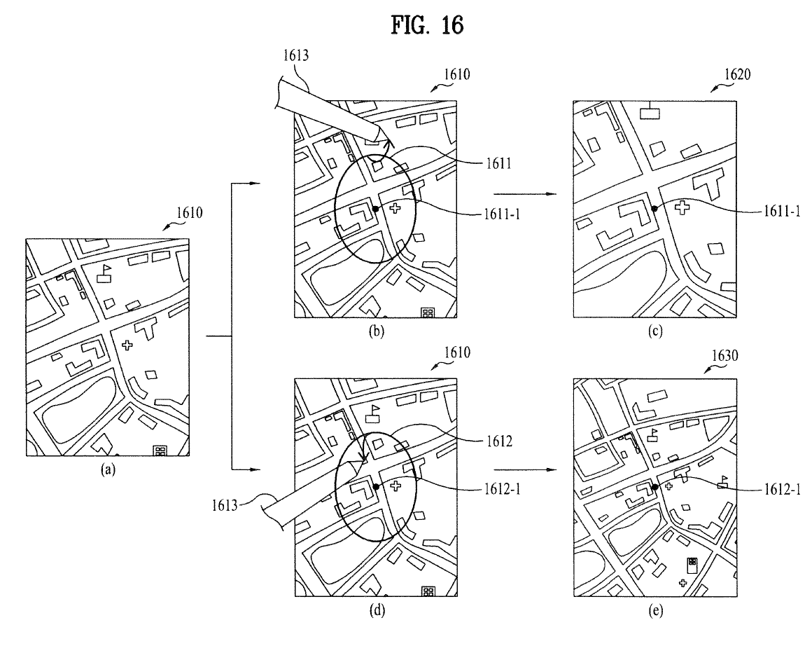

In case that a circle 1511 for an area setting is drawn ‘counterclockwise’ on the touchscreen, the mobile terminal 100 recognizes a touch action as an image zoom-out command and then displays an image 1510 by zooming out the image 1510. FIG. 16 is a diagram for a second screen configuration for a zoom-in/out process in accordance with a touch pattern on a touchscreen according to one embodiment.

Referring to FIG. 16, after a circle 1611 for an area setting has been drawn on the touchscreen, if a point of ending a drag action of a pointer 1613 is located outside the circle 1611, the mobile terminal 100 recognizes a touch action as an image zoom-in command and then displays an image 1610 by zooming in the image 1610. After a circle 1611 for an area setting has been drawn on the touchscreen, if a point of ending a drag action of a pointer 1613 is located within the circle 1611, the mobile terminal 100 recognizes a touch action as an image zoom-out command and then displays an image 1610 by zooming out the image 1610.

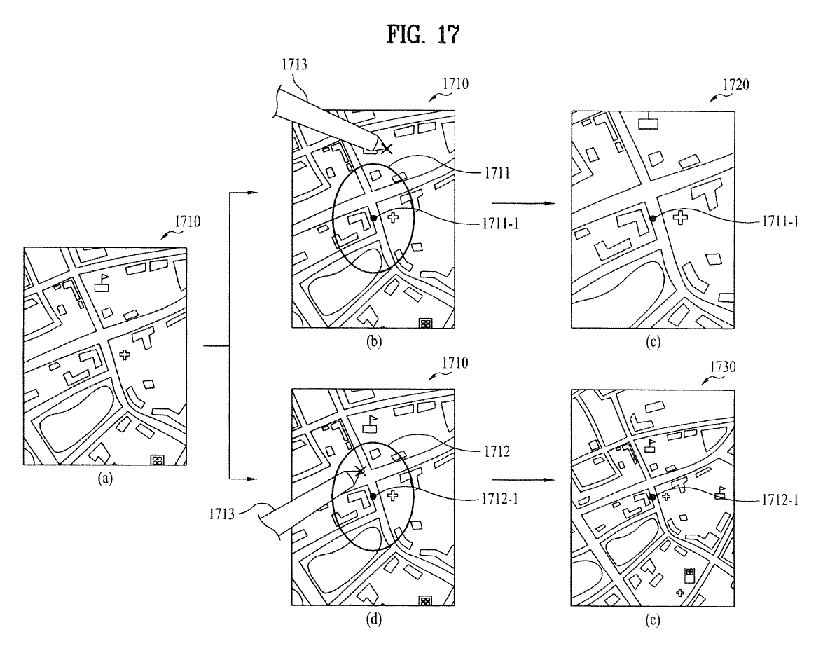

FIG. 17 is a diagram for a third screen configuration for a zoom-in/out process in accordance with a touch pattern on a touchscreen according to one embodiment. Referring to FIG. 17, after a circle 1711 for an area setting has been drawn on the touchscreen, if a specific point of an outer area of the circle 1711 is touched by a pointer 1713, the mobile terminal 100 recognizes a touch action as an image zoom-in command and then displays an image 1710 displayed in the state by zooming in the image 1710.

After a circle 1711 for an area setting has been drawn on the touchscreen, if a specific point of an inner area of the circle 1711 is touched by a pointer 1713[d], the mobile terminal 100 recognizes a touch action as an image zoom-out command and then displays an image 1710 displayed in the state (a) by zooming out the image 1710[e].

According to one embodiment, the above-described terminal screen size controlling method can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the controller 180 of the mobile terminal 100.

Accordingly, the present disclosure provides the following effects and/or advantages. In one embodiment, the present device zooms in or out an image displayed on a touchscreen to correspond to an area setting action performed on the touchscreen. In one embodiment, the present device is able to freely control a zoom-in or zoom-out extent of an image to correspond to an area setting action performed on a touchscreen.

It will be apparent to those skilled in the art that various modifications and variations can be made in the present invention without departing from the spirit or scope of this disclosure. Thus, it is intended that the present disclosure covers the modifications and variations of this disclosure provided they come within the scope of the appended claims and their equivalents.

What is claimed is:

1. A method of graphically resizing content displayed on a portion of a display screen of a mobile communication terminal, the method comprising:
selecting a first area of an image graphically rendered on a display screen, content in the first area having a first set of dimensions and a first central point in a first relationship with boundaries of the first area; and
graphically re-rendering the content in the first area on the display screen such that the content in the first area is displayed on the display screen in a second area of the screen having a second set of dimensions and a second central point having proportionally the first relationship with boundaries of the second area.

2. The method of claim 1, wherein the second area is larger than the first area, in response to receiving a first command, and wherein the second area is smaller than the first area, in response to receiving a second command.

3. The method of claim 2, wherein the first command is a command to zoom-in on the first area, and the second command is a command to zoom-out of the first area.

4. The method of claim 3, wherein selecting the first area comprises drawing a geometric shape around the first area, wherein the first command is associated with a first direction selected to draw the geometric shape, and the second command is associated with a second direction selected to draw the geometric shape.

5. The method of claim 4, where in the second direction is opposite to the first direction.

6. The method of claim 5, wherein the shape is approximately an ellipse, the first direction is clockwise and the second direction is counter clockwise.

7. The method of claim 5, wherein level of zoom-in and zoom-out is controlled according to speed with which the geometric shape is drawn.

8. The method of claim 5, wherein level of zoom-in and zoom-out is controlled according to number of times the geometric shape is drawn.

9. The method of claim 7, wherein the level of zoom-in and zoom-out is doubled if speed of the speed with which the geometric shape is drawn is doubled.

10. The method of claim 8, the level of zoom-in and zoom-out is doubled if speed of the number of times the geometric shape is drawn is doubled.

11. A mobile communication terminal comprising:
a touch-sensitive display screen;
a logic unit for selecting a first area of an image graphically rendered on a display screen, wherein content displayed in the first area have a first set of dimensions and a first central point in a first relationship with boundaries of the first area; and
a logic unit for graphically re-rendering the content in the first area on the display screen such that the content in the first area is displayed on the display screen in a second area of the screen having a second set of dimensions and a second central point having proportionally the first relationship with boundaries of the second area.

12. The mobile communication terminal of claim 1, wherein the second area is larger than the first area, in response to receiving a first command, and wherein the second area is smaller than the first area, in response to receiving a second command.

13. The mobile communication terminal of claim 2, wherein the first command is a command to zoom-in on the first area, and the second command is a command to zoom-out of the first area.

14. The mobile communication terminal of claim 3, wherein selecting the first area comprises drawing a geometric shape around the first area, wherein the first command is associated with a first direction selected to draw the geometric shape, and the second command is associated with a second direction selected to draw the geometric shape.

15. The mobile communication terminal of claim 4, where in the second direction is opposite to the first direction.

16. The mobile communication terminal of claim 5, wherein the shape is approximately an ellipse, the first direction is clockwise and the second direction is counter clockwise.

17. The mobile communication terminal of claim 5, wherein level of zoom-in and zoom-out is controlled according to speed with which the geometric shape is drawn.

18. The mobile communication terminal of claim 5, wherein level of zoom-in and zoom-out is controlled according to number of times the geometric shape is drawn.

19. The mobile communication terminal of claim 7, wherein the level of zoom-in and zoom-out is doubled if speed of the speed with which the geometric shape is drawn is doubled.

20. The mobile communication terminal of claim 8, the level of zoom-in and zoom-out is doubled if speed of the number of times the geometric shape is drawn is doubled.
